(19) United States
(12) Patent Application Publication
(10) Pub. No.: US 2008/0281444 A1
(43) Pub. Date: Nov. 13, 2008

(54) PREDICTIVE MODELING SYSTEM AND METHOD FOR FANTASY SPORTS

(75) Inventors: Franklyn M. Krieger, Celebration, FL (US); Ari Wirtschafter, Celebration, FL (US)

Correspondence Address: AKERMAN SENTERFITT, P.O. BOX 3188, WEST PALM BEACH, FL, 33402-3188, US

(73) Assignee: Sports Prophet, LLC, Celebration, FL (US)

(21) Appl. No.: 12/111,054

(22) Filed: Apr. 28, 2008

Related U.S. Application Data
(60) Provisional application No. 60/914,499, filed on Apr. 27, 2007.
(60) Provisional application No. 60/970,688, filed on Sep. 7, 2007.

(51) Int. Cl. G06F 19/00

(52) U.S. Cl. 700/91

(57) ABSTRACT

A prediction engine for use in predictive modeling associated with fantasy sports leagues is provided. The prediction engine can have a database module for storing criteria associated with players; and an information modeling module in communication with the database module for generating relationships among the criteria and providing player projections based at least in part on the relationships. The relationships can be adjusted based at least in part on changes to a scoring system of the fantasy sports league.

### CROSS-REFERENCE TO RELATED APPLICATIONS

This application claims priority to U.S. Provisional Application No. 60/914,499, filed on Apr. 27, 2007 and claims priority to U.S. Provisional Application No. 60/970,688, filed Sep. 7, 2007, the disclosures of which are both hereby incorporated by reference.

### FIELD OF THE INVENTION

The present disclosure relates generally to predictive modeling, and more specifically to a predictive modeling system and method for fantasy sports.

### BACKGROUND

Fantasy games and in particular sports fantasy leagues are becoming widespread throughout the United States and the world. Fantasy sports are games that allow sports fans to take an active role in professional or collegiate sports by creating their own team and competing with teams built by others. Fans create their own roster of players by “drafting” talent from actual professional or collegiate sports teams and compete based upon those players' real-life performance in professional or collegiate games. The sports fantasy leagues can be based upon a number of different sports, including football, baseball, basketball, hockey, soccer and other sports. The sports fantasy leagues can be based upon a number of different leagues or associations within a sport, for example a football fantasy sports league can be based upon the National Football League or can be based upon Collegiate football, or a baseball league can be based only on the Major League Baseball's National League or American League. Some sports fantasy leagues can be even more limiting, and restrict the sports fantasy league to only certain teams or even certain categories of players.

Sports fantasy leagues are often provided over the Internet, such as YAHOO!® SPORTS fantasy leagues or ESPN fantasy leagues. However, the different sports fantasy leagues often include different scoring systems that can make certain players more valuable in one sports fantasy league as opposed to another sports fantasy league. Scoring systems and the corresponding fantasy points generated are based upon actual player performance in a particular game or event. Additionally, the use of different sports leagues, associations, teams or player restrictions can also effect the value of players in one sports fantasy league as opposed to another sports fantasy league.

The sports fantasy leagues typically have a draft that is a timed event. The goal of the draft is to choose the players that the fantasy sport participant believes will generate the most fantasy points. Users choose actual professional or collegiate players based upon published statistics for that player and “draft” the player onto their fantasy team based upon availability and whatever information they have gathered. Preparation for the draft can be a time consuming effort, especially where the sports fantasy league scoring system is not fully understood or changes. Additionally, the choice of the players can be a tedious process, especially where the format is merely a name and position appearing on a computer screen.

A need therefore exists for a predictive modeling system and method for fantasy sports.

### SUMMARY OF THE INVENTION

Broadly stated, embodiments of the invention are directed to a predictive modeling system and method for fantasy sports.

In one embodiment of the present disclosure, a prediction engine for use in predictive modeling associated with fantasy sports leagues can be provided. The prediction engine can have a database module for storing criteria associated with players; and an information modeling module in communication with the database module for generating relationships among the criteria and providing player projections based at least in part on the relationships. The relationships can be adjusted based at least in part on a different scoring system of the fantasy sports league.

In another embodiment of the present disclosure, a computer-readable storage medium, such as in a server, can be provided with computer instructions for retrieving player data representative of criteria associated with players of a fantasy sports league; generating relationships among the criteria; and providing player projections based at least in part on the relationships. The relationships can be adjusted based at least in part on changes to the criteria occurring during a fantasy sports draft of the players.

In another embodiment of the present disclosure, a method of assisting a user in a fantasy sports league can involve retrieving player data representative of criteria associated with players of the fantasy sports league; generating relationships among the criteria; providing player projections based at least in part on the relationships; and adjusting the relationships based at least in part on at least one among a different scoring system of the fantasy sports league and changes to the criteria occurring during a fantasy sports draft of the players.

### BRIEF DESCRIPTION OF THE DRAWINGS

The embodiments herein, can be understood by reference to the following description, taken in conjunction with the accompanying drawings, in the several figures of which like reference numerals identify like elements, and in which:

FIG. 1 is a schematic view of a prediction engine for use in predictive modeling associated with fantasy sports leagues, according to one embodiment of a system;

FIG. 2 is a flowchart of steps in a method for assisting a user in a fantasy sports league in accordance with the system of FIG. 1;

FIG. 3 is a block diagram of interfacing in the predictive modeling system of FIG. 1;

FIG. 4 is a block diagram of data flow in the predictive modeling system of FIG. 1; and

FIGS. 5a-5c are a block diagram of predictive modeling in accordance with the predictive modeling system of FIG. 1.

### DETAILED DESCRIPTION

While the specification concludes with claims defining some of the features of the embodiments of the invention that are regarded as novel, it is believed that the method, system, and other embodiments will be better understood from a consideration of the following description in conjunction with the drawing figures, in which like reference numerals are carried forward. Additionally, other features of the embodiments of the invention may be novel.

As required, detailed embodiments of the present method and system are disclosed herein. However, it is to be understood that the disclosed embodiments are merely exemplary, and can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiments herein.

The terms “a” or “an” as used herein, are defined as one or more than one. The term “plurality” as used herein, is defined as two or more than two. The term “another” as used herein, is defined as at least a second or more. The terms “including” and/or “having” as used herein, are defined as comprising (i.e., open language). The term “coupled” as used herein, is defined as connected, although not necessarily directly, and not necessarily mechanically. The term “program” as used herein is defined as system of services, opportunities, or projects, generally designed to meet a social need.

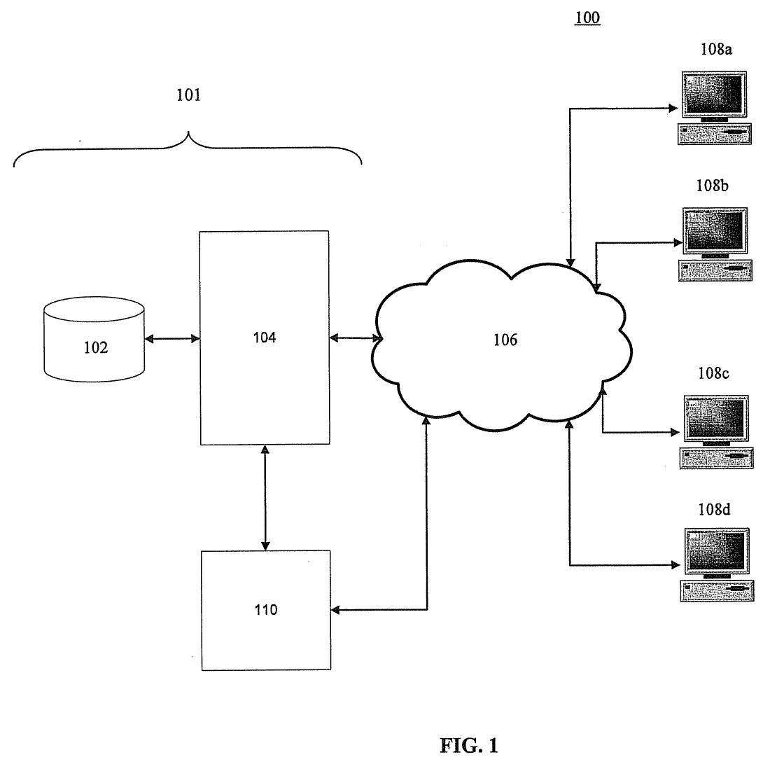

Referring to FIGS. 1-5c, a sports fantasy predictive modeling system is shown and generally referred to by reference numeral 100, while one exemplary embodiment of implementation of the predictive modeling is shown in method 200. System 100 can apply advanced analytics/predictive modeling (“AA/PM”) to various criteria (e.g., player performance or fantasy performance data) associated with fantasy sports leagues, including those leagues that are already in existence. System 100 can analyze historical data as part of the predictive model (e.g., 40 years of data) and can establish relational databases for use in the predictive model. System 100 can utilize AA/PM to predict fantasy point production in a number of different leagues having different scoring systems.

FIG. 1 illustrates a schematic view of a prediction engine 101 of the system 100 for use in predictive modeling associated with fantasy sports leagues, according to one embodiment of the system. The prediction engine 101 can include a database module 102 for storing or otherwise accessing criteria or information associated with the sports league, such as statistics of various sports players. The present disclosure also contemplates other criteria or information associated with the sports league being stored or otherwise accessible by the database module, such as statistics related to particular venues (e.g., baseball homeruns at a particular ballpark) or statistics related to particular time frames and/or weather conditions (e.g., football touchdowns scored in Green Bay in December). While prediction engine 101 depicts one database module 102, one of ordinary skill in the art would recognize that the database module can be any number of components, working in cooperation or independently of each other, such as in a centralized system or in a decentralized system. The present disclosure also contemplates the database module 102 being incorporated into a component (e.g., a server) having other components of prediction engine 101 as will be discussed later. The database module 101 can store the criteria or information, can access the criteria or information that is being stored by one or more other databases (e.g., a third party database), or can utilize a combination of storage and outside accessing of the criteria and information. The system 100 can include an information modeling module 104 in communication with the database module 102. The information modeling module 104 can be communicatively linked to users 108a-d of the system 100 via the Internet or other network 106. Even though four users 108a-d are shown, it will be apparent to one of ordinary skill in the art, that a greater or lesser number of users can access and interact with the prediction engine 101. The system 100 can also include a league performance center module 110, which can be communicatively linked to the information modeling module 104 and the users 108a-d via the network 106. The information modeling module 104, league performance center module 110 and/or the database module 102 can be incorporated into a single component or can be incorporated into any number of components in various arrangements.

Operatively, the database module 102 can store or otherwise access various criteria or information associated with the league, including the players, and can send all or a portion of the criteria to the information modeling module 104. The information modeling module 104 can generate relationships among the criteria, and can provide player projections based at least in part on the relationships. The relationships among the criteria can be adjusted based at least in part on a different scoring system of the fantasy sports league, such as changes made to the default scoring system of the league by a commissioner or other moderator. The criteria can comprise an availability of a player for draft selection. The users 108a-d can make decisions based upon the provided player projections. The system 100 can include a user interface, where the different scoring system can be inputted by users 108a-d through the user interface.

The information modeling module 104 can be configured to receive rule signals from the user interface, where the rule signals are representative of a scoring system, or a portion thereof, of the fantasy sports league. For example, a user 108a can input scoring rules particular to the user and have the rules sent to the information modeling module 104. Additionally, the information modeling module 104 can be configured to generate player projections after the actual league has commenced. In generating the player projections, the information modeling module 104 can compile and/or utilize player performance data or other league information (e.g., variations in statistics based on venues) for the missed portion of the season and can adjust the relationships among the criteria accordingly. As an example, a user 108b might have only signed up for a particular fantasy league after the football season has started. Although the user 108b has missed a portion of the season, the user can rely on projections taking into account a particular player's most recent performances for the missed portion of the season, instead of having to rely on preseason projections.

The information modeling module 104 can be implemented in hardwired, dedicated circuitry for performing the operative functions described herein. In another embodiment, the information modeling module 104 can be implemented in computer-readable code configured to execute on a particular computing machine. In yet another embodiment, however, the information modeling module can be implemented in a combination of hardwired circuitry and computer-readable code

Operatively, the league performance center module 110, which can be communicatively linked to the information modeling module 104, can allow a user to have access to real-time league information from multiple league hosting sites. For example, in one embodiment, if a user 108c has fantasy leagues in a variety of different sites, the league performance center module 110 can allow the user 108c to view all the updated fantasy point totals on one display screen simultaneously.

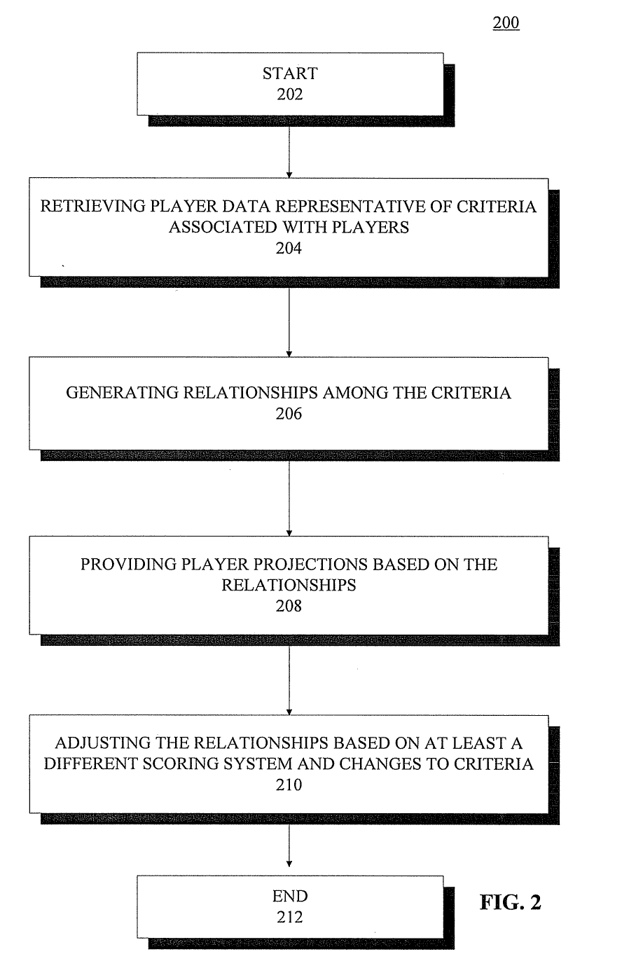

Referring now to FIG. 2, a flowchart is provided that illustrates steps associated with the prediction engine 101. The flowchart depicts steps of a method 200 that can be implemented by the system 100 for assisting a user in a fantasy sports league, although the present disclosure contemplates other steps being utilized by the system 100 which may or may not include one or more of the steps of method 200. The method 200 can include, after the start step 202, retrieving player data representative of criteria associated with players of the particular sports league at step 204. The retrieval of data can also include other criteria or information associated with the league such as statistics based on venue, timeframe, weather, and so forth. Additionally, the method 200 can include, at step 206, generating relationships among the various criteria. The method, at step 208, can include providing player projections based at least in part on the relationships generated at step 206. Furthermore, the method 200 can include adjusting the relationships based at least in part on changes to a default scoring system of the fantasy sports league and/or can include adjusting the relationships based at least in part on changes to the criteria occurring during a fantasy sports draft of the players at step 210. The method illustratively concludes at step 212.

According to one embodiment, the method 200 implemented by the system 100 can also include generating player projections after the actual league has commenced. Generating the player projections can comprise compiling and utilizing player performance data for the missed portion of the season and adjusting the relationships among the criteria accordingly. The method 200 can further include providing a league performance center, where the league performance center allows users 108a-d to have access to real-time league information from multiple league hosting sites.

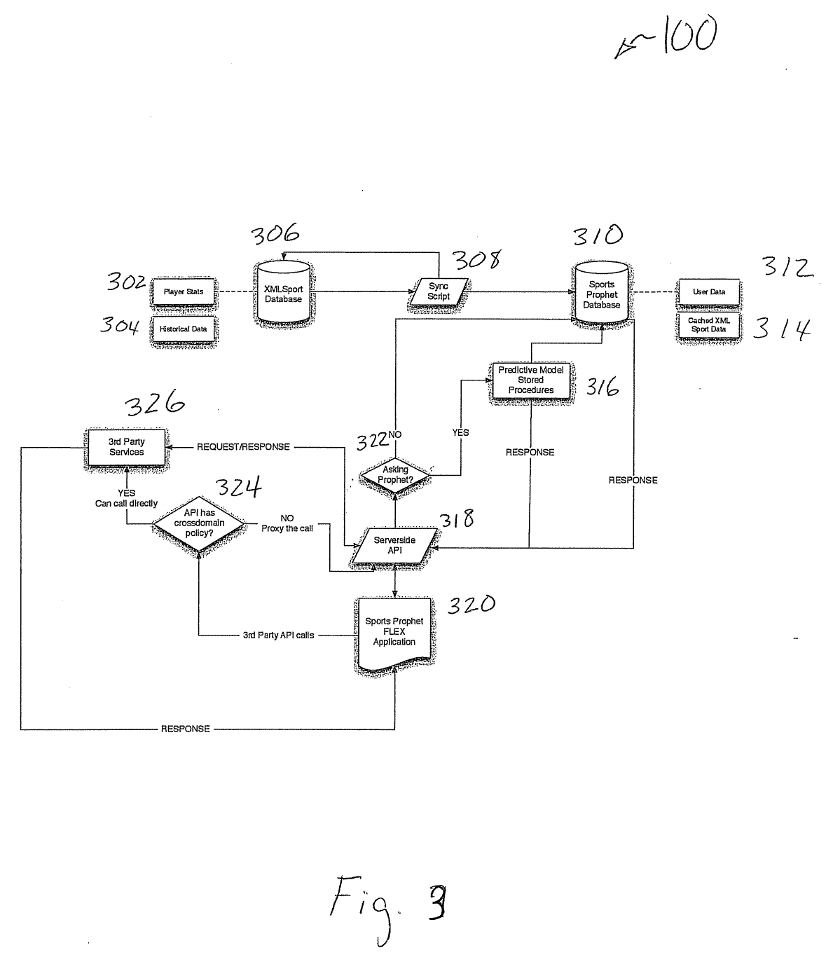

FIG. 3 illustrates a block diagram of interfacing in the system 100. In one embodiment for the system 100, player statistics 302 and historical data 304 can be loaded into an XML sport database 306. The XML sport database 306 can communicate with a synchronization script, which contains a set of instructions for interacting with the player statistics 302 and historical data 304. The statistics 302 and data 304 can be entered into the database 310, which can optionally receive user data 312 and/or cached XML data 314. The database 310 can send a response to a server side application program interface (API), which, in turn can check to see whether or not the user wants a projection 322. If the answer is no, then the data is directed to the database 310, however, if the answer is yes, then the data can be sent to the predictive model 316 for processing. After processing, the data can be sent to the database 310 and a response can be sent back to the server side API 318.

The server side API 318 also can communicate with a FLEX Application 320, which processes third party API calls, and can check to see whether the API has a cross-domain policy 324. If there is a cross-domain policy 324, a direct call can be made to third party services 326, from which a response can be sent back to the FLEX Application 320 and/or the server side API 318. If there is no cross-domain policy, then system 100 can proxy the call back at the server side API 318.

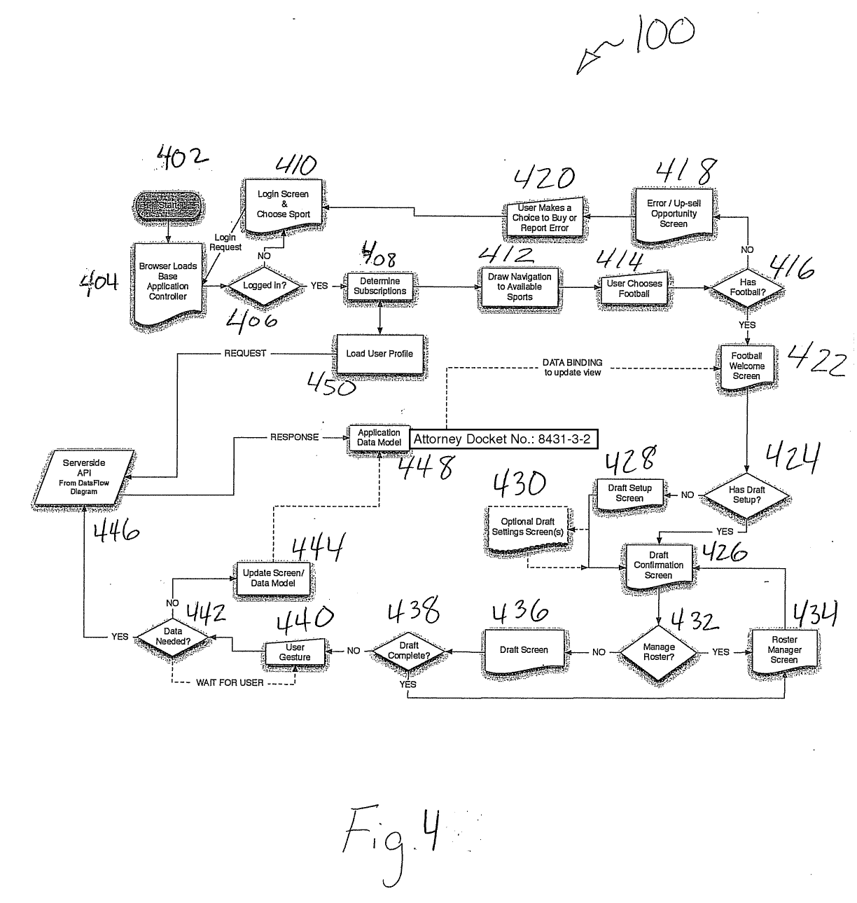

FIG. 4 illustrates a block diagram of data flow in the system 100. The block diagram illustratively starts at 402. From there, a user's browser can load a base application controller at step 404 and a check can be performed to see whether or not the user has performed a login to the website at step 406. If the user has not performed the login at step 406, the user can be prompted with a login screen at step 410 where the user can login. The system 100 can check to see again whether or not the user is properly logged in at step 406 and, if so, determines the user's subscriptions at step 408. After the system 100 determines the subscriptions at step 408, the user's profile is loaded at step 450, a request is sent to the server side API at step 446, and the user is prompted to choose from a list of available sports at step 412. If football is chosen at step 414, for example, the system 100 can determine whether or not the user has signed up for the fantasy football league at step 416. If not, the user can be directed to an error/up-sell opportunity screen at step 418, where the user can then buy a subscription or the system 100 can report an error at step 420. Once a user purchases a particular league at step 420 the user is directed to the login screen where they can login and choose the newly purchased league at step 410. If the user already has a football league at step 416 then a fantasy football welcome screen at step 422 can be displayed to the user.

Upon seeing the user welcome screen at step 422, the system 100 can communicate with the application data model at step 448 and can check to see whether or not the user's draft has been set up at step 424. If the draft has not been set up at step 424, then the user is prompted to a draft setup screen at step 428, where the user can directly go to a draft confirmation screen at step 426 or the user can optionally select draft settings at step 430 for the draft before being directed to the draft confirmation screen at step 426. When a user has a draft already setup at step 424, then the user can be directed straight to the draft confirmation screen at step 426, which then prompts the user if user wants to manage their fantasy roster at step 432. If the user wants to manage their fantasy roster at step 432 then the a roster manager screen at step 434 is displayed where a user can manage their roster and then be redirected to the draft confirmation screen at step 426. When the user is not managing a roster at step 432 then the user can be directed to a draft screen at step 436. The system 100 can then check to see whether or not a draft has been completed at step 438 and, if so, redirects the user back to the roster manager screen at step 434. However, if the user has not completed a draft at step 438 then, based on a user gesture at step 440, it can be determined whether data is needed at step 442. The system 100 can optionally wait for the user. If there is no data needed at step 442 then the user can access an update screen/data model at step 444, which can then communicate with the application data model at step 448. If there is data needed at step 442, then a signal can be sent to the server side API at step 446, which can relay a response to the application data model at step 448.

System 100 can provide a user with accurate player projections that are compatible with the scoring system in the particular fantasy sports league. In one embodiment, system 100 can provide a user interface for input of the scoring rules associated with the particular fantasy sports league. The user is then provided with player projections based on the league's scoring system criteria. For example, if the league is a touchdown-only fantasy football scoring league, system 100 can adjust its analysis and predictive model to generate a player projection list that is different from a league using another scoring system. System 100 can adjust the predictive model based upon a number of different criteria associated with a particular sport, such as in football where distances are rewarded. System 100 can adjust its analysis and predictive model based upon the different scoring criteria, rather than only utilizing conversion factors for adjusting the value of one or more players. System 100 can apply AA/PM for the projection of the components of the fantasy points as outlined by a particular fantasy sports league.

In another embodiment, the user interface can provide a selection of rules from which a user can choose and which can be the basis of the analysis and predictive model of system 100. In yet another embodiment, the user interface of system 100 can retrieve the scoring criteria to be applied in the analysis and predictive model based upon identification of a particular fantasy league by a user. For example, a user can input, or select from a list displayed at the user interface, the fantasy league that is being played (e.g., ESPN® fantasy sports baseball league). The user interface can provide a confirmation of the scoring criteria being used, which can be helpful where a particular fantasy sports league has different scoring systems that can be chosen from.

In one embodiment, system 100 can provide the total projected points of the user's opponents throughout each round of the draft. This provides a user with instant feedback by allowing comparison of the user's draft selections with the competitors' draft selections.

In one embodiment, system 100 can provide side-by-side player profile comparisons. The player profile comparison can include a player action photo, player career statistics and/or the projected player fantasy point production based upon the individual league scoring system.

In one embodiment, system 100 can provide an analysis and predictive model that is dynamic based upon the on-going draft. System 100 can maximize the draft selection by analyzing and adjusting the predictive model based upon a number of criteria, including criteria that change as the draft is in progress. For example, system 100 can utilize criteria including player rankings, opponents' choices, the players already selected, probability of available players being chosen by opponents and the current round of the draft. As another example, if all of the competitors had already selected a quarterback during the draft and the user has a choice between selecting a very high-ranked wide receiver or a quarterback, system 100 can utilize this information in its analysis. In this example, the opponents may not be likely to select a second quarterback so early in the draft, so it may be advantageous for the user to wait until the next round before selecting a quarterback based upon probability of the quarterback being available for selection. As yet another example, the system 100 can utilize the predictive modeling criteria of players that are allowed, or are otherwise eligible, for use in the fantasy sports league. For instance, a league may limit the number of players at a position that can be utilized (e.g., only two running backs per team) or may limit the particular positions that can be filled on a team, such as not utilizing a designated hitter position in a fantasy sports league. Other player limitations can also be implemented and an analyzed by system 100, including use of players from separate leagues (e.g., different soccer leagues) or use of players from a particular conference or division of a league, such as only National League players in baseball.

In one embodiment, system 100 can provide player recommendations, such as through a pop-up window, so that the on-going draft interface of the fantasy sports league is not interrupted but the player recommendation is received. The player recommendation information or window can display the top-rated players at each individual position, and can provide information as to selections that would not be beneficial to the user for that draft round. In one embodiment, system 100 can remove from the display in the player recommendation window selections that are not beneficial to a user, such as a defense or special teams pick in the first round of a football draft where the particular point scoring system of the league makes this a non-beneficial selection. In yet another embodiment, system 100 can remove from the display in the player recommendation window selections that have been drafted by the drafting participant or other league players.

In one embodiment, system 100 can select players for a user from a player recommendations list by applying the analysis and predictive model described above. The auto-pick feature can be a safeguard against forfeiting a selection in a round due to lack of time, especially at later rounds where selections can be more difficult to make.

In another embodiment, system 100 can provide an auto-draft to select the players for the user. The auto-draft can be adapted for the particular league and its selection techniques. The auto-draft can blend the player recommendations, player rankings, drafting algorithm and auto pick features to perform this convenient function pursuant to the analysis and dynamic predictive model generated by system 100.

In one embodiment, system 100 provides a position tracker to facilitate the selection of players during the draft. The position tracker can provide a user-friendly interface for selection of the players, as compared to a text-only interface. The interface can include visual, audio and a combination thereof of representative information for the draft selection. In one embodiment, a pictorial/cartoon can display figurines/silhouettes in their standard line-up that in turn would become highlighted as a player was selected to fill that position. This would give visual feedback to a user as they complete the draft. This would balance having to look at simply multiple lists and make it more like a multimedia experience. As opposed to looking at a list of players selected by position, a user would have a visual image of what he had selected and what was still out-standing. In another embodiment, a user could also click on that silhouette and the list of active players for that position would become available just as if the subscriber had selected that particular list from the tool bar. In yet another embodiment, an audible message can be provided that describes information associated with the selection, including name, statistics, comparisons with other players at that particular position, predictions for the upcoming season, and so forth. The information can be provided in a combination of an audible and visual presentation.

System 100 can allow a user to rank multiple lists of players by projected points, regardless of position. In another embodiment, a user can also rank players segregated by individual position. System 100 can allow a user to view an individual player, including information such as action photo, career statistics, and individualized point projections. System 100 can provide a draft clock that displays the time left to make the draft choice.

System 100 can provide updated career statistics on all players. Selecting an individual player can bring up that player's photo. In one embodiment, system 100 can assess the value of a trade utilizing the predictive model and give the information needed before actually making the trade. A user can enter one player or multiple players. System 100 can display the players for trading in a side-by-side comparison, with initial player projections, photos, updated career statistics and updated fantasy point totals. In another embodiment, system 100 applies a dynamic predictive model to trades, such as by analyzing criteria as it occurs during the season such as current statistics, injuries, other trades that have occurred or are being offered, and/or team statistics associated with the players.

In one embodiment, system 100 can update projections based on the AA/PM predictive model at pre-selected times, such as mid-season updates. This feature can be helpful with rookie players as well as experienced regulars who see more playing time than expected in the preseason—for example, a replacement for an injured starter. A user can also use this feature to help decide whether to pick up any free agents who may have been overlooked. In another embodiment, a user can select when to update the projections. In yet another embodiment, the predictive model is updated in real-time or near real time to provide a dynamic predictive model that is adjusted according to criteria that can change as the season is on-going. In yet another embodiment, the dynamic predictive model can be adjusted according to only a limited number of criteria that change as the season is on-going. In such an embodiment, the limited number of criteria can be pre-determined and/or selected by a user. For example, a user or system 100 may implement an update of the predictive model in real-time according to player injuries or other criteria that are determined to have a higher potential impact according to the particular scoring system of the league.

In one embodiment, system 100 can provide a league performance center or team aggregator. The league performance center can allow a user to view all of the user's teams' updated fantasy point totals even though they may be from different league hosting sites. System 100 can communicate with the league hosting sites (e.g., AOL, CBS Sportsline, Yahoo, etc.) to obtain league level information through API's/Web Services. In another embodiment, a user can maintain an updated weekly roster of active players entered in the system 100 along with having entered at the beginning of the season the league's individual league scoring rules to enable the league performance center. With the live-feed, scoring rules in place, and a list of active players, system 100 can calculate fantasy point productions even without an API for that specific league hosting site.

In one embodiment, system 100 can provide a player alert tool. A user can pre-register a list of players that they wish to acquire and will be alerted when those players become available. With the updated projections generated at a pre-determined or selected time, such as mid-season, a user can be alerted if there is a significant change in point predictions for a given player.

System 100 can be used by a user in various formats and through various terminal devices. For example, system 100 can communicate with and provide a user interface for various mobile devices, including wireless telephones and PDA's.

In one embodiment, system 100 can provide a “virtual community” whereby the users can interact with each other and share their fantasy sport's experiences. The virtual community can allow for posting their team at the Winners Circle or Hall of Shame. In one embodiment, system 100 can archive players for a Legacy League. The Legacy League can allow users to keep a certain number of players from one year to the next.

In one embodiment, system 100 can utilize criteria in the predictive model that includes non-statistical data. For example, system 100 can combine analysis of historical data with other predictions, such as sports writers' picks over a specified time period. In one embodiment, a group of sports writers preseason picks can be compared by system 100 with post-season results to create an accuracy scale. The accuracy scale can be entered as an additional variable into the predictive model. The accuracy scale can be especially helpful for evaluating those players who have very limited historical data. The accuracy scale can also be used in generating player projections for non-rookie players.

System 100 can provide both on-line and off-line capability. In one embodiment, system 100 can be used without a web browser. System 100 can provide various user interfaces to facilitate operation, including a drag and drop interface. System 100 can allow for use of a mouse to move players from one position to another on the screen, and/or customization of the screen views. System 100 can provide for data import and export capability. For example, a user can send team data to other users, as well as other individuals who are not subscribers to the system 100, including team data associated with team's statistics, or a user can interface with other league hosts. System 100 can be compatible with fantasy sports leagues that impose a salary cap. For example, system 100 can keep track of expenditures during a draft. System 100 can also apply AA/PM techniques to calculating dollars for individual players to assist in player selections and trades.

In one embodiment, system 100 can generate charts and/or graphs for tracking a user's team's performance in a variety of ways. Also, users can have the ability to analyze player information in multiple ways. In another embodiment, system 100 can be integrated with television programming, such as a live game. In this embodiment, system 100 can display a user interface on the television screen so that the user can interface with system 100 while watching the game. The television programming can be provided by various services, including IPTV. System 100 can provide an on-line tutorial. System 100 can provide multi-year projections.

System 100 can provide other features including commissioner service capability (league management services); an advanced league performance center or team aggregator where users have access to real-time league level information in a multi-quadrant screen that allows feeds from multiple league hosting sites; mock draft capability where users have the ability to simulate a draft for learning purposes; write in players where new players become available; and player flagging (tagging) where users manage lists of players during the draft by highlighting them in any suitable manner. System 100 can also provide content compatible (strategy articles) where the ability to receive and display articles/content of game analysis both pre and post game is provided; minor league player data; depth charts with the ability to display up-to-date depth charts; schedule of strength data; interface customization by a user; advanced search capability; the ability to support multiple draft styles including serpentine, auction, standard; and the ability to sort statistics in resizable columns.

System 100 can be a software package installed locally or remotely on a client's computer, a server, a network, or over the internet. System 100 can be a Windows-based, Unix-based, Linux-based, or any other suitable operating system-based user interface environment that presents results in an easy-to-use interface, which can be a web interface. System 100 can provide a user-interface that allows for highly efficient data visualization, data exploration, and predictive modeling.

In one embodiment, system 100 can collect data, including historic data of players statistics. The data can be partitioned and combined to create a comprehensive and relational process. The grouped data can be scrubbed to clean up the process. Original variables can be transformed into a set of derived variables. Information mining can be performed and a predictive model can be created from the mined data. A combination of linear and non-linear models to correctly fit characteristics of the data can be used. System 100 can examine multiple combinations of predictors on an outcome to determine which interaction terms contribute the most to a predictive model.

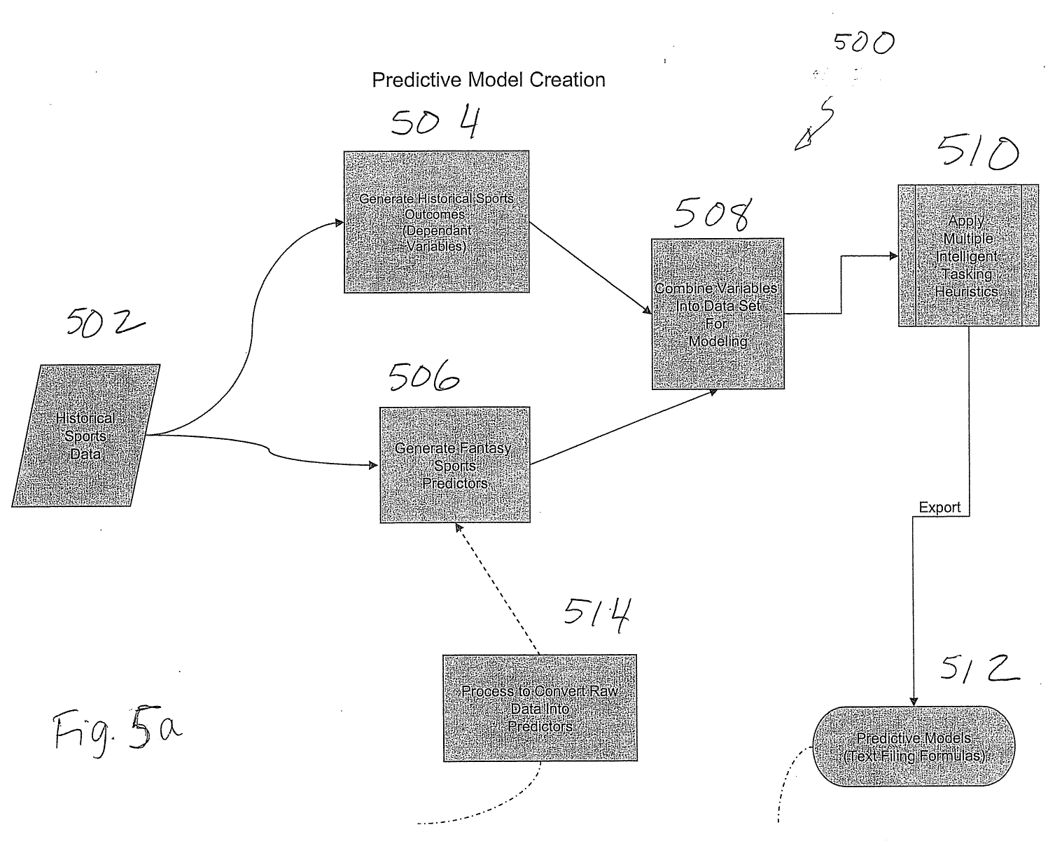

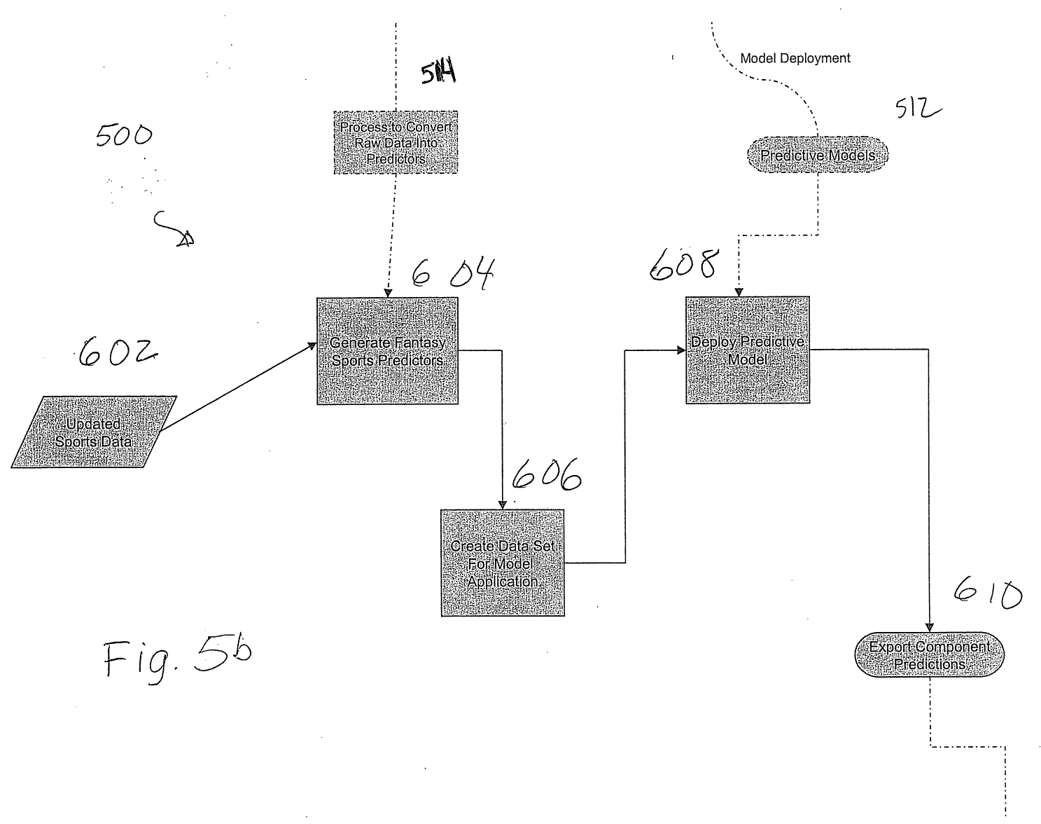

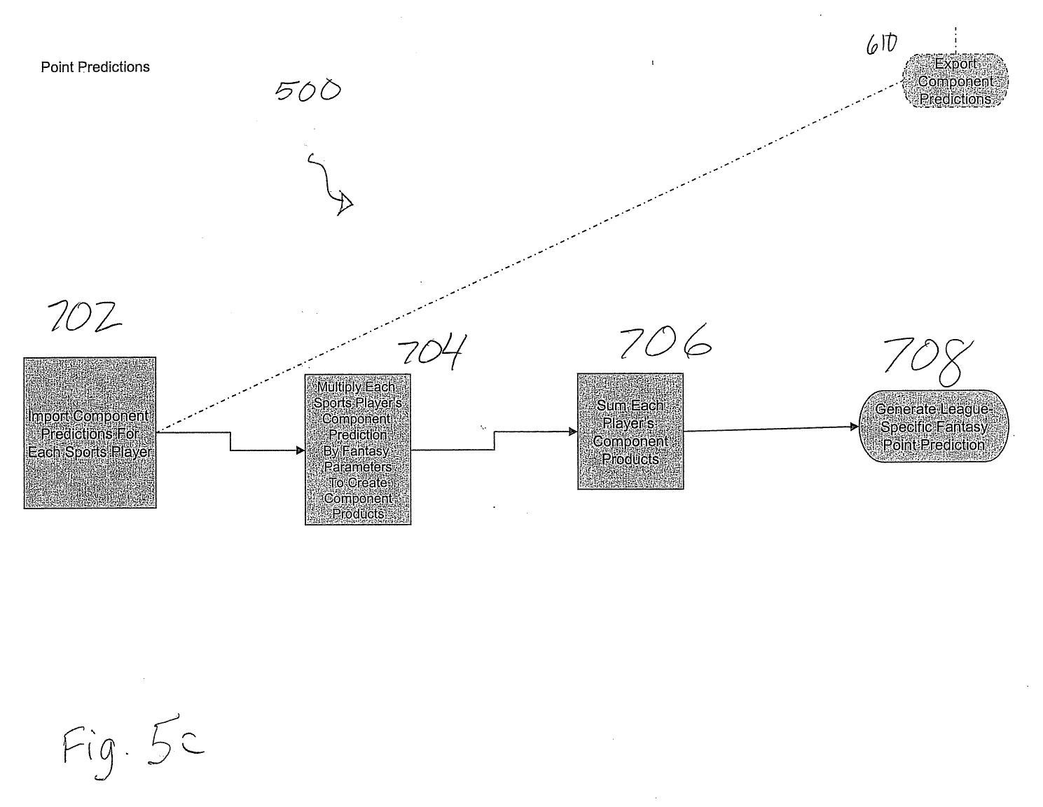

Referring now to FIG. 5a for one embodiment, the predictive model creation 500 can import historical sports data 502, and can create from this data historical sports outcomes 504, which are dependant variables. The historical sports data 502 can be over an entire career of a player or can be only over a portion of the player's career. For example, a player's performance during the first few years of his career may not be a good predictor of his performance when the player is in his prime. Other factors can also be used for determining how much of the player's career should be included in the historical sports data, such as where a player was playing for a different team or playing a different position.

The historical sports data 502 can also be used to generate fantasy sports predictors 506. In generating the fantasy sports predictors 506, the predictive model creation 500 utilizes a process to convert raw data into predictors 514. The fantasy sports predictors 506 and the historical sports outcome variables 504 can be combined into a data set 508 for modeling. This data set 508 can be imported into a modeling program, such as a heuristics program 510, from which predictive models can be generated. Referring to FIGS. 5a-b, as updated sports data 602 becomes available, fantasy sports predictors 604 can also be created from updated sports data 602 as a sports season progresses. In creating the fantasy sports predictors 604, a process is utilized to convert raw data into predictors 514. The fantasy sports data 604 can be used to create a data set 606 for a predictive model application. This data set 606 can be deployed 608 in the predictive models 512 generated from the historical data 502 to provide component predictions 610, which are exported into the system 100. Referring now to FIG. 5b-c, the component predictions 610 for each sports player can then be imported 702 into system 100. Each sports player's component prediction 702 can be multiplied by fantasy parameters to create component products 704. Each player's component products are then summed 706 to generate a league-specific fantasy point prediction 708.

System 100 can also provide for retrospective scoring in a single league or in multiple leagues such as through the league performance center. For example, system 100 can utilize criteria from past seasons for the predictive modeling. The criteria can be based on fantasy points earned by a player for past seasons. For instance, system 100 can discern fantasy points earned over the past three years based on the scoring system of the current fantasy league. The system 100 can also obtain the fantasy points earned by a particular player from different leagues, such as fantasy points earned during a senior year of college football and a rookie season in the National Football League. As another example, where a fantasy league begins after the start of the actual league, the system 100 can compile and utilize player performance from the missed portion of the season.

As another example of retrospective scoring, player performance data from the missed portion of the actual season can be used as part of the predictive model, such as in combination with historical data from previous seasons. The amount of the season that has been played can be used as a variable by system 100 in the predictive model. For example, a player's performance where only a few games have been played in the season may not influence the predictive model as much as a player's performance where half the season has been played.

Where applicable, the present embodiments can be realized in hardware, software or a combination of hardware and software. Any kind of computer system or other apparatus adapted for carrying out the methods described herein is suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A prediction engine for use in predictive modeling associated with fantasy sports leagues, the prediction engine comprising:
a database module for storing criteria associated with players; and
an information modeling module in communication with the database module for generating relationships among the criteria and providing player projections based at least in part on the relationships, wherein the relationships are adjusted based at least in part on a different scoring system of the fantasy sports league.

2. The prediction engine of claim 1, wherein the criteria comprises an availability of a player for draft selection.

3. The prediction engine of claim 1, further comprising a user interface, wherein at least a portion of the different scoring system is inputted by a user through the user interface.

4. The prediction engine of claim 3, wherein the information modeling module is configured to receive rule signals from the user interface, wherein the rule signals are representative of at least a portion of a scoring system of the fantasy sports league.

5. The prediction engine of claim 1, wherein the information modeling module is configured to generate player projections after the fantasy sports league has commenced.

6. The prediction engine of claim 5, wherein the information modeling module utilizes player performance data for a missed portion of a season and adjusts the relationships among the criteria based at least in part on the player performance data for the missed portion of the season.

7. The prediction engine of claim 1, further comprising a league performance center module communicatively linked to the information modeling module, wherein the league performance center module provides a user with access to league information from multiple league hosting sites.

8. A computer-readable storage medium comprising computer instructions for:
retrieving player data representative of criteria associated with players of a fantasy sports league;
generating relationships among the criteria; and
providing player projections based at least in part on the relationships, wherein the relationships are adjusted based at least in part on changes to the criteria occurring during a fantasy sports draft of the players.

9. The storage medium of claim 8, wherein the criteria comprises an availability of a player for draft selection.

10. The storage medium of claim 8 wherein the relationships are adjusted based at least in part on a different scoring system of the fantasy sports league.

11. The storage medium of claim 8, comprising computer instructions for receiving rule signals from a user interface, wherein the rule signals are representative of a scoring system of the fantasy sports league.

12. The storage medium of claim 8, comprising computer instructions for adjusting the player projections based upon player performance compiled after the fantasy sports league has commenced.

13. The storage medium of claim 12, wherein the adjusting of the player projections comprises utilizing player performance data for a missed portion of a season.

14. The storage medium of claim 8, comprising computer instructions for providing a user with access to real-time league information from multiple league hosting sites.

15. A method of assisting a user in a fantasy sports league, the method comprising:
retrieving data representative of information associated with the fantasy sports league;
generating relationships among the criteria;
providing player projections based at least in part on the relationships; and
adjusting the relationships based at least in part on at least one among a different scoring system of the fantasy sports league and changes to the criteria occurring during a fantasy sports draft of the players.

16. The method of claim 15, wherein the criteria comprises an availability of a player for draft selection.

17. The method of claim 15, wherein rule signals are received from a user interface, and wherein the rule signals are representative of the different scoring system of the fantasy sports league.

18. The method of claim 15, wherein the player projections are generated after the fantasy sports league has commenced.

19. The method of claim 18, wherein the generating of the player projections comprises utilizing player performance data for a missed portion of a season and adjusting the relationships among the criteria based at least in part on the player performance data for the missed portion of the season.

20. The method of claim 15, further comprising providing a user with access to real-time league information from multiple league hosting sites on a single display screen.
